(19) United States
(12) Patent Application Publication
(10) Pub. No.: US 2026/0322560 A1
(43) Pub. Date: Oct. 15, 2026

(54) APPARATUS AND METHOD OF WIRELESS COMMUNICATION

(71) Applicant: GUANGDONG OPPO MOBILE TELECOMMUNICATIONS CORP., LTD., Dongguan (CN)

(72) Inventor: Li GUO, Allen, TX (US)

(21) Appl. No.: 19/696,177

(22) Filed: Jun. 2, 2026

Related U.S. Application Data
(63) Continuation of application No. PCT/CN2024/121460, filed on Sep. 26, 2024.
(60) Provisional application No. 63/606,486, filed on Dec. 5, 2023.

(51) Int. Cl. H04L 5/00; H04W 4/029

(52) U.S. Cl. CPC H04L 5/0051; H04W 4/029

(57) ABSTRACT

A method of wireless communication performed by a user equipment (UE) includes receiving a configuration of at least one positioning reference signal from a base station, where the configuration of the at least one positioning reference signal comprises whether the at least one positioning reference signal is transmitted in a superimposed manner with respect to a communication channel, and measuring the at least one positioning reference signal to obtain at least one positioning measurement result.

### CROSS-REFERENCE TO RELATED APPLICATION

The present disclosure is a Continuation Application of PCT/CN2024/121460, filed on Sep. 26, 2024, which claims priority to U.S. Provisional Patent Application No. 63/606,486, filed on Dec. 5, 2023. The above referenced applications are incorporated herein by reference in their entirety.

### TECHNICAL FIELD

The present disclosure relates to the field of communication systems, and more particularly, to apparatuses and methods of wireless communication.

### BACKGROUND

In the existing positioning method, a positioning reference signal cannot be transmitted in the same time-frequency resource as other communication channels or reference signal. For a user equipment (UE) to measure downlink (DL) positioning reference signal, a system would have to configure some measurement gaps for positioning measurement. Within a time window configured in the measurement gap, the UE does not receive any communication channel or reference signal, but the UE is only able to received and measure the positioning reference signal. That cause a few severe issues to the whole system. The normal data transmission has to be paused when the UE receives the positioning reference. Thus, a system data throughput is impaired. That also increases a latency of normal data transmission and thus a service performance is degraded.

Therefore, there is a need for apparatuses and methods of wireless communication.

### SUMMARY

In a first aspect of the present disclosure, a method of wireless communication of a user equipment (UE) includes receiving a configuration of at least one positioning reference signal from a base station, wherein the configuration of the at least one positioning reference signal includes whether the at least one positioning reference signal is transmitted in a superimposed manner with respect to a communication channel, and measuring the at least one positioning reference signal to obtain at least one positioning measurement result.

In a second aspect of the present disclosure, a UE includes a receiver and a measurer. The receiver is configured to receive a configuration of at least one positioning reference signal from a base station, wherein the configuration of the at least one positioning reference signal includes whether the at least one positioning reference signal is transmitted in a superimposed manner with respect to a communication channel. The measurer is configured to measure the at least one positioning reference signal to obtain at least one positioning measurement result.

In a third aspect of the present disclosure, a UE includes a memory, a transceiver, and a processor coupled to the memory and the transceiver. The UE is configured to perform the above method.

In a fourth aspect of the present disclosure, a method of wireless communication of a base station includes transmitting, to a user equipment (UE), a configuration of at least one positioning reference signal, wherein the configuration of the at least one positioning reference signal includes whether the at least one positioning reference signal is transmitted in a superimposed manner with respect to a communication channel, and requesting the UE to measure the at least one positioning reference signal to obtain at least one positioning measurement result.

In a fifth aspect of the present disclosure, a base station includes a transmitter and a requester. The transmitter is configured to transmit, to a user equipment (UE), a configuration of at least one positioning reference signal, wherein the configuration of the at least one positioning reference signal includes whether the at least one positioning reference signal is transmitted in a superimposed manner with respect to a communication channel. The requester is configured to request the UE to measure the at least one positioning reference signal to obtain at least one positioning measurement result.

In a sixth aspect of the present disclosure, a base station includes a memory, a transceiver, and a processor coupled to the memory and the transceiver. The base station is configured to provide the above method.

In a seventh aspect of the present disclosure, a non-transitory machine-readable storage medium has stored thereon instructions that, when executed by a computer, cause the computer to perform the above method.

In an eighth aspect of the present disclosure, a chip includes a processor, configured to call and run a computer program stored in a memory, to cause a device in which the chip is installed to execute the above method.

In a ninth aspect of the present disclosure, a non-transitory computer readable storage medium, in which a computer program is stored, causes a computer to execute the above method.

In a tenth aspect of the present disclosure, a computer program product includes a computer program, and the computer program causes a computer to execute the above method.

In an eleventh aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1A is a schematic diagram of an example of multi-transmission/reception point (TRP) based non-coherent joint transmission.

FIG. 1B is a schematic diagram of another example of multi-TRP transmission.

FIG. 1C is a schematic diagram of an example of positioning based on downlink (DL) measurement.

FIG. 2 is a block diagram of one or more user equipments (UEs) and a base station of communication in a communication network system according to an embodiment of the present disclosure.

FIG. 3 is a block diagram of a UE according to an embodiment of the present disclosure.

FIG. 4 is a block diagram of a UE according to an embodiment of the present disclosure.

FIG. 5 is a flowchart illustrating a method of wireless communication performed by a UE according to an embodiment of the present disclosure.

FIG. 6 is a block diagram of a base station according to an embodiment of the present disclosure.

FIG. 7 is a block diagram of a base station according to an embodiment of the present disclosure.

FIG. 8 is a flowchart illustrating a method of wireless communication performed by a base station according to an embodiment of the present disclosure.

FIG. 9 is a block diagram of an example of a computing device according to an embodiment of the present disclosure.

FIG. 10 is a block diagram of a communication system according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

The technical solutions of the embodiments of the present disclosure can be applied to various communication systems, such as a global system of mobile communication (GSM) system, a code division multiple access (CDMA) system, a wideband code division multiple access (WCDMA) system, a general packet radio service (GPRS), a long term evolution (LTE) system, a LTE frequency division duplex (FDD) system, a LTE time division duplex (TDD) system, an advanced long term evolution (LTE-A) system, a new radio (NR) system, an evolution system of a NR system, a LTE-based access to unlicensed spectrum (LTE-U) system, a NR-based access to unlicensed spectrum (NR-U) system, an universal mobile telecommunication system (UMTS), a global interoperability for microwave access (WiMAX) communication system, wireless local area networks (WLAN), wireless fidelity (Wi-Fi), a future 5th generation (5G) system (may also be called a new radio (NR) system) or other communication systems, etc.

Optionally, a base station mentioned in the embodiments of the present application can provide a communication coverage for a specific geographic area and can communicate with a user equipment (UE) located in the coverage area. Optionally, the base station may be a gNB, a base transceiver station (BTS) in the GSM or in the CDMA system, or may be a NodeB (NB) in the WCDMA system, or may be an evolutional Node B (eNB or eNodeB) in the LTE system, or a radio controller in a cloud radio access network (CRAN).

A user equipment (UE) may refer to an access terminal, a subscriber unit, a subscriber station, a mobile station, a remote station, a remote terminal, a mobile device, a user terminal, a terminal, a wireless communication device, a user agent, or a user device. The access terminal may be a cellular radio telephone, a cordless telephone, a session initiation protocol (SIP) telephone, a wireless local loop (WLL) station, a personal digital assistant (PDA), a handheld device with wireless communication functions, a computing device, other processing devices coupled with a wireless modem, an in-vehicle device, a wearable device, a terminal device in a future 5G network, a terminal device in a future evolved public land mobile network (PLMN), etc.

Optionally, the communication system in the embodiment of the present application may be applied to an unlicensed spectrum, where the unlicensed spectrum may also be considered as a shared spectrum; or the communication system in the embodiment of the present application may also be applied to a licensed spectrum, where the licensed spectrum can also be considered an unshared spectrum.

New radio (NR) system introduces multi-transmission/reception point (TRP) based non-coherent joint transmission and also coherent joint transmission. In non-coherent joint transmission, multiple TRPs are connected through one or more backhaul links for coordination. The backhaul link can be ideal or non-ideal. In the case of ideal backhaul communication, the TRPs can exchange dynamic physical downlink shared channel (PDSCH) scheduling information with short latency and thus different TRPs can coordinate the PDSCH transmission per PDSCH transmission. While, in the case of non-ideal backhaul communication, the information exchange between TRPs has an undesirable latency, and thus, the coordination between TRPs can only be semi-static or static.

In non-coherent joint transmission, different TRPs use different physical downlink control channels (PDCCHs) to schedule the PDSCH transmission independently. Each TRP can send one downlink control information (DCI) on the PDCCH to schedule one PDSCH transmission. PDSCHs from different TRPs can be scheduled in the same slot or different slots. Two different PDSCH transmissions from different TRPs can be fully overlapped or partially overlapped in PDSCH resource allocation.

To support multi-TRP based non-coherent joint transmission, a user equipment (UE) is requested to receive PDCCH from multiple TRPs, and then, receive PDSCH sent from multiple TRPs. For each PDSCH transmission, the UE can feedback a hybrid automatic repeat request (HARQ)-acknowledgement (ACK) information to the network. In multi-TRP transmission, the UE can feedback the HARQ-ACK information for each PDSCH transmission to the TRP transmitting the PDSCH. The UE can also feedback the HARQ-ACK information for a PDSCH transmission sent from any TRP to one particular TRP.

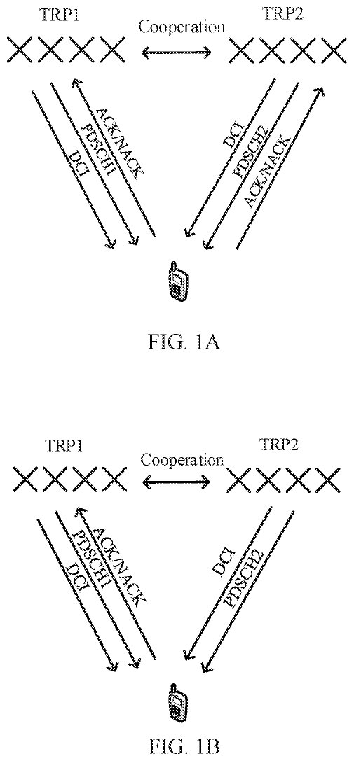

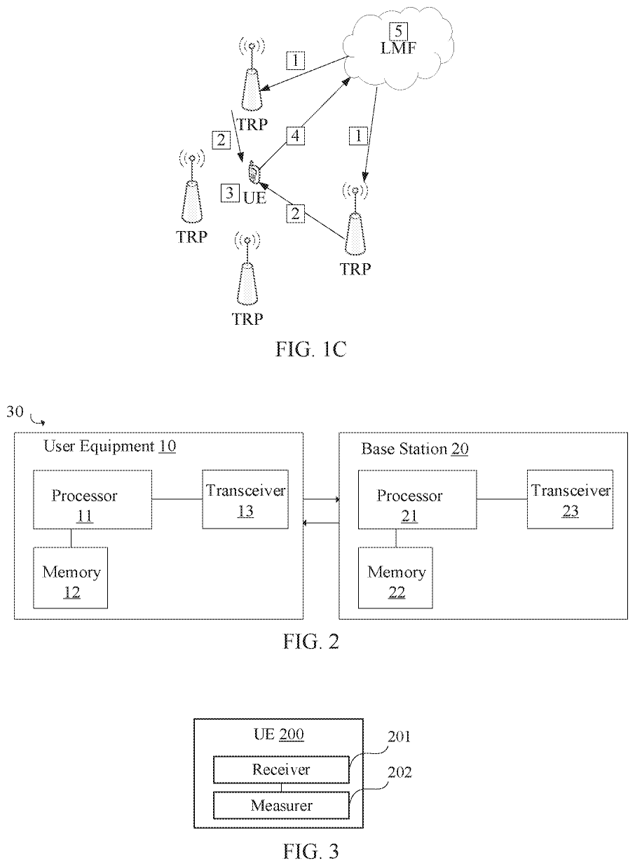

An example of multi-TRP based non-coherent joint transmission is illustrated in FIG. 1A. A UE receives a PDSCH based on non-coherent joint transmission from two TRPs: TRP1 and TRP2. As illustrated in FIG. 1A, the TRP1 sends one downlink control information (DCI) to schedule the transmission of PDSCH1 to the UE, and TRP2 sends one DCI to schedule the transmission of PDSCH2 to the UE. At the UE side, the UE receives and decodes the DCI from both TRPs. Based on the DCI from TRP1, the UE receives and decodes PDSCH1, and based on the DCI from TRP2, the UE receives and decodes PDSCH2. In the example illustrated in FIG. 1A, the UE reports HARQ-ACK for PDSCH1 and PDSCH2 to the TRP1 and TRP2, respectively. TRP1 and TRP2 use different control resource sets (CORESETs) and search spaces to transmit DCI scheduling PDSCH transmission to the UE. Therefore, a network can configure multiple CORESETs and search spaces. Each TRP can be associated with one or more CORESETs and also the related search spaces. With such a configuration, the TRP would use the associated CORESET to transmit DCI to schedule a PDSCH transmission to the UE. The UE can be requested to decode the DCI in CORESETs associated with either TRP to obtain PDSCH scheduling information.

Another example of multi-TRP transmission is illustrated in FIG. 1B. A UE receives a PDSCH based on non-coherent joint transmission from two TRPs: TRP1 and TRP2. As illustrated in FIG. 1B, the TRP1 sends one DCI to schedule the transmission of PDSCH1 to the UE, and TRP2 sends one DCI to schedule the transmission of PDSCH2 to the UE. At the UE side, the UE receives and decodes the DCI from both TRPs. Based on the DCI from TRP1, the UE receives and decodes PDSCH1, and based on the DCI from TRP2, the UE receives and decodes PDSCH 2. In the example illustrated in FIG. 1B, the UE reports HARQ-ACK for both PDSCH1 and PDSCH2 to the TRP, which is different from the HARQ-ACK reporting in the example illustrated in FIG. 1A. The example shown in FIG. 1B needs ideal backhaul between TRP 1 and TRP 2, while the example illustrated in FIG. 1A can be deployed in the scenarios that the backhaul between TRP1 and TRP2 is ideal or non-ideal.

Positioning technology is one of the core technologies of wireless communications systems and navigation systems. 5G NR system supports positioning technology. In 3rd generation partnership project (3GPP) release 16, the following positioning solutions are specified: downlink (DL) time difference of arrival (TDOA) method, uplink (UL) TDOA method, multi round trip time (RTT) method, DL angle of departure (AoD) method, UL angle of arrival (AoA) method, and enhanced cell identification (E-CID) method.

In 3GPP NR, downlink positioning reference signal (PRS) is introduced to support downlink positioning measurement and sounding reference signal (SRS) for positioning is introduced to support uplink positioning measurement. For instance, the following measurements for positioning are supported in NR release 16: DL reference signal time difference (RSTD) measured from DL PRS, UL relative time of arrival (RTOA) measured from SRS for positioning, UE receive transmission (Rx-Tx) time difference, gNB Rx-Tx time difference, DL PRS reference signal received power (RSRP), UL SRS RSRP, and UL AoA.

The NR based positioning solutions involve the following function entities:

UE: the UE measures DL PRS resources sent from multiple different TRPs or transmits SRS resource for positioning.

transmission/reception point (TRP): For determining the location of one UE, multiple TRPs are involved generally. Each TRP can transmit DL PRS to the UE or receive and measure SRS for positioning transmitted by the UE.

Location server: it can be referred to as location management function (LMF).

FIG. 1C illustrates an example of NR positioning based on DL measurement. As illustrated in the example, the basic procedure includes at least one of the following operations: The LMF and TRP coordinate the DL PRS configurations. Each TRP transmits DL PRS resource according to the configuration. The UE measures DL PRS resources transmitted from multiple TRPs and then measures the DL PRS RSRP and/or DL RSTD. The UE reports the positioning measurement results to the LMF. At last, the LMF calculates the location of the UE based on the reported positioning measurement results. Specially, in DL-AoD methods, the UE measures the RSRP or path RSRP of one or more DL RS resources and then report the measurement results to LMF. The LMF can determine the angle of departure of one UE with respect to each TRP and then the LMF can calculate the location of the UE.

As specified in NR, the UE can be configured with one or more DL PRS resource sets, and each DL PRS resource set can consist of one or more DL PRS resources. For each DL PRS resource set, the UE is provided with the following configuration parameters:
dl-PRS-Periodicity-and-ResourceSetSlotOffset defines the DL PRS resource periodicity and takes values

$${T}_{per}^{PRS} ∈ {2}^{μ} [ \begin{matrix}4 , & 5 , & 8 , & 10 , & 16 , & 20 , \\ 32 , & 40 , & 64 , & 80 , & 160 , & 320 , \\ 640 , & 1280 , & 2560 , & 5120 , & 10240 & \end{matrix} ] slots ,$$

where μ=0, 1, 2, 3 for dl-PRS-SubcarrierSpacing=15, 30, 60 and 120 kHz respectively and the slot offset for DL PRS resource set with respect to SFN0 slot 0. All the DL PRS resources within one DL PRS resource set are configured with the same DL PRS resource periodicity. dl-PRS-MutingOption1 and dl-PRS-MutingOption2 define the time locations where the DL PRS resource is expected to not be transmitted for a DL PRS resource set. If dl-PRS-MutingOption1 is configured, each bit in the bitmap of dl-PRS-MutingOption1 corresponds to a configurable number provided by higher layer parameter dl-prs-MutingBitRepetitionFactor of consecutive instances of a DL PRS resource set where all the DL PRS resources within the set are muted for the instance that is indicated to be muted. The length of the bitmap can be {2, 4, 6, 8, 16, 32} bits. If dl-PRS-MutingOption2 is configured each bit in the bitmap of dl-PRS-MutingOption2 corresponds to a single repetition index for each of the DL PRS resources within each instance of a nr-DL-PRS-ResourceSet and the length of the bitmap is equal to the values of dl-PRS-ResourceRepetitionFactor.

NR-DL-PRS-SFN0-Offset defines the time offset of the SFN0 slot 0 for the transmitting cell with respect to SFN0 slot 0 of reference cell.

The bandwidth of DL PRS resource could be outside the bandwidth of one active bandwidth part (BWP) and the subcarrier spacing used by a DL PRS resource could be different from the subcarrier spacing of an active BWP, too. Thus, a measurement gap is needed for a UE to measure DL PRS resource. The measurement gap for positioning is configured through radio resource control (RRC). When a UE needs to measure DL PRS resource and there is no measurement gap, the UE can request measurement gap through RRC signaling.

There are also uplink-based positioning methods. One UE transmits SRS for positioning in uplink to multiple TRPs. Each TRP receives the SRS for positioning from that UE and obtain the corresponding measurement results, which can be arrival timing measurement (called RSTD), SRS RSRP measurement or angle of arrival measurement. Then the TRP reports those measurement results to the LMF. The LMF can estimate the location of UE based on uplink measurements reported from multiple TRPs.

In the existing positioning method, a positioning reference signal cannot be transmitted in the same time-frequency resource as other communication channels or reference signal. For a user equipment (UE) to measure downlink (DL) positioning reference signal, a system would have to configure some measurement gaps for positioning measurement. Within a time window configured in the measurement gap, the UE does not receive any communication channel or reference signal, but the UE is only able to received and measure the positioning reference signal. That cause a few severe issues to the whole system. The normal data transmission has to be paused when the UE receives the positioning reference. Thus, a system data throughput is impaired. That also increases a latency of normal data transmission and thus a service performance is degraded.

To overcome these and other challenges, some embodiments of the present disclosure provide some solutions for transmission and measurement of superimposed positioning reference signals, as detailed below.

FIG. 2 illustrates that, in some embodiments, one or more user equipments (UEs) 10 and a base station (e.g., next generation NodeB (gNB) or eNB) 20 of communication in a communication network system 30 (e.g., an NR system) according to an embodiment of the present disclosure are provided. The communication network system 30 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the transceiver 13 is configured to receive a configuration of at least one positioning reference signal from the base station 20, wherein the configuration of the at least one positioning reference signal includes whether the at least one positioning reference signal is transmitted in a superimposed manner with respect to a communication channel. The processor 11 is configured to measure the at least one positioning reference signal to obtain at least one positioning measurement result. This can solve issues in the prior art and other issues, boost a spectral efficiency of a whole system, reduce a system transmission latency, and/or reduce a positioning service latency.

In some embodiments, the transceiver 23 is configured to transmit, to the UE 10, a configuration of at least one positioning reference signal, wherein the configuration of the at least one positioning reference signal includes whether the at least one positioning reference signal is transmitted in a superimposed manner with respect to a communication channel. The processor 21 is configured to request the UE 10 to measure the at least one positioning reference signal to obtain at least one positioning measurement result. This can solve issues in the prior art and other issues, boost a spectral efficiency of a whole system, reduce a system transmission latency, and/or reduce a positioning service latency.

FIG. 3 illustrates an example of a UE 200 according to an embodiment of the present application. The UE 200 is configured to implement some embodiments of the disclosure. Some embodiments of the disclosure may be implemented into the UE 200 using any suitably configured hardware and/or software. The UE 200 includes a receiver 201 and a measurer 202. The receiver 201 is receive a configuration of at least one positioning reference signal from a base station, wherein the configuration of the at least one positioning reference signal includes whether the at least one positioning reference signal is transmitted in a superimposed manner with respect to a communication channel. The measurer 202 is configured to measure the at least one positioning reference signal to obtain at least one positioning measurement result. This can solve issues in the prior art and other issues, boost a spectral efficiency of a whole system, reduce a system transmission latency, and/or reduce a positioning service latency.

FIG. 4 illustrates an example of a UE 300 according to an embodiment of the present disclosure. The UE 300 is configured to implement some embodiments of the disclosure. Some embodiments of the disclosure may be implemented into the UE 300 using any suitably configured hardware and/or software. The UE 300 may include a memory 301, a transceiver 302, and a processor 303 coupled to the memory 301 and the transceiver 302. The processor 303 may be configured to implement proposed functions, procedures and/or methods described in this description. Layers of radio interface protocol may be implemented in the processor 303. The memory 301 is operatively coupled with the processor 303 and stores a variety of information to operate the processor 303. The transceiver 302 is operatively coupled with the processor 303, and the transceiver 302 transmits and/or receives a radio signal. The processor 303 may include application-specific integrated circuit (ASIC), other chipset, logic circuit and/or data processing device. The memory 301 may include read-only memory (ROM), random access memory (RAM), flash memory, memory card, storage medium and/or other storage device. The transceiver 302 may include baseband circuitry to process radio frequency signals. When the embodiments are implemented in software, the techniques described herein can be implemented with modules (e.g., procedures, functions, and so on) that perform the functions described herein. The modules can be stored in the memory 301 and executed by the processor 303. The memory 301 can be implemented within the processor 303 or external to the processor 303 in which case those can be communicatively coupled to the processor 303 via various means as is known in the art.

In some embodiments, the transceiver 302 is configured to receive a configuration of at least one positioning reference signal from a base station, wherein the configuration of the at least one positioning reference signal includes whether the at least one positioning reference signal is transmitted in a superimposed manner with respect to a communication channel. The processor 303 is configured to measure the at least one positioning reference signal to obtain at least one positioning measurement result. This can solve issues in the prior art and other issues, boost a spectral efficiency of a whole system, reduce a system transmission latency, and/or reduce a positioning service latency.

FIG. 5 is an example of a method 400 of wireless communication performed by a UE according to an embodiment of the present disclosure. The method 400 of wireless communication performed by a UE is configured to implement some embodiments of the disclosure. Some embodiments of the disclosure may be implemented into the method 400 of wireless communication performed by a UE using any suitably configured hardware and/or software. In some embodiments, the method 400 of wireless communication performed by a UE includes: an operation 402, receiving a configuration of at least one positioning reference signal from a base station, wherein the configuration of the at least one positioning reference signal includes whether the at least one positioning reference signal is transmitted in a superimposed manner with respect to a communication channel, and an operation 404, measuring the at least one positioning reference signal to obtain at least one positioning measurement result. This can solve issues in the prior art and other issues, boost a spectral efficiency of a whole system, reduce a system transmission latency, and/or reduce a positioning service latency.

In some embodiments, the at least one positioning reference signal being transmitted in the superimposed manner with respect to the communication channel includes the at least one positioning reference signal being transmitted on a same time-frequency resource as a physical downlink control channel (PDCCH), a physical downlink shared channel (PDSCH), and/or a channel state information reference signal (CSI-RS). In some embodiments, the at least one positioning measurement result includes an arrival time difference of the at least one positioning reference signal of different transmit points (TPs), a reference signal received power (RSRP) measurement of the at least one positioning reference signal, a carrier phase measurement of the at least one positioning reference signal, and/or or a measurement of arrival time of the at least one positioning reference signal. In some embodiments, measuring the at least one positioning reference signal includes: measuring the at least one positioning reference signal transmitted in the superimposed manner outside a measurement gap, and the measurement gap is a time window within which there is no transmission of other channels or other reference signals.

In some embodiments, the UE is provided with a power-scaling factor when the at least one positioning reference signal is transmitted in a superimposed manner. In some embodiments, the power-scaling factor is used to indicate a power offset between the at least one positioning reference signal and the PDCCH, the PDSCH, or the CSI-RS. In some embodiments, if the at least one positioning reference signal transmitted in the superimposed manner is not measured or the at least one positioning reference signal dose not overlap the communication channel, the UE is supposed to measure the at least one positioning reference signal within a measurement gap. In some embodiments, the UE is requested to use a positioning service level to determine whether measuring the at least one positioning reference signal transmitted in the superimposed manner to obtain at least one positioning measurement result. In some embodiments, the UE is configured to receive a PDCCH, a PDSCH and/or a CSI-RS. In some embodiments, the UE is indicated whether the at least one positioning reference signal is transmitted along with the PDCCH, the PDSCH or the CSI-RS in the superimposed manner.

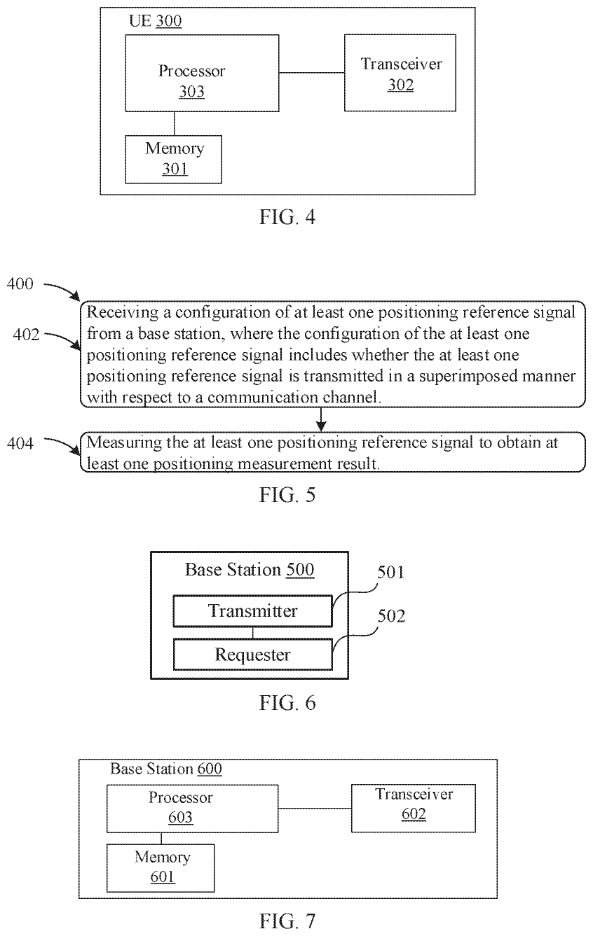

FIG. 6 illustrates an example of base station 500 according to an embodiment of the present application. The base station 500 is configured to implement some embodiments of the disclosure. Some embodiments of the disclosure may be implemented into the base station 500 using any suitably configured hardware and/or software. The base station 500 includes a transmitter 501 and a requester 502. The transmitter 501 is configured to transmit, to a user equipment (UE), a configuration of at least one positioning reference signal, wherein the configuration of the at least one positioning reference signal includes whether the at least one positioning reference signal is transmitted in a superimposed manner with respect to a communication channel. The requester 502 is configured to request the UE to measure the at least one positioning reference signal to obtain at least one positioning measurement result. This can solve issues in the prior art and other issues, boost a spectral efficiency of a whole system, reduce a system transmission latency, and/or reduce a positioning service latency.

FIG. 7 illustrates an example of a base station 600 according to an embodiment of the present disclosure. The base station 600 is configured to implement some embodiments of the disclosure. Some embodiments of the disclosure may be implemented into the base station 600 using any suitably configured hardware and/or software. The base station 600 may include a memory 601, a transceiver 602, and a processor 603 coupled to the memory 601 and the transceiver 602. The processor 603 may be configured to implement proposed functions, procedures and/or methods described in this description. Layers of radio interface protocol may be implemented in the processor 603. The memory 601 is operatively coupled with the processor 603 and stores a variety of information to operate the processor 603. The transceiver 602 is operatively coupled with the processor 603, and the transceiver 602 transmits and/or receives a radio signal. The processor 603 may include application-specific integrated circuit (ASIC), other chipset, logic circuit and/or data processing device. The memory 601 may include read-only memory (ROM), random access memory (RAM), flash memory, memory card, storage medium and/or other storage device. The transceiver 602 may include baseband circuitry to process radio frequency signals. When the embodiments are implemented in software, the techniques described herein can be implemented with modules (e.g., procedures, functions, and so on) that perform the functions described herein. The modules can be stored in the memory 601 and executed by the processor 603. The memory 601 can be implemented within the processor 603 or external to the processor 603 in which case those can be communicatively coupled to the processor 603 via various means as is known in the art.

In some embodiments, the transceiver 602 is configured to transmit, to a UE, a configuration of at least one positioning reference signal, wherein the configuration of the at least one positioning reference signal includes whether the at least one positioning reference signal is transmitted in a superimposed manner with respect to a communication channel. The processor 603 is configured to request the UE to measure the at least one positioning reference signal to obtain at least one positioning measurement result. This can solve issues in the prior art and other issues, boost a spectral efficiency of a whole system, reduce a system transmission latency, and/or reduce a positioning service latency.

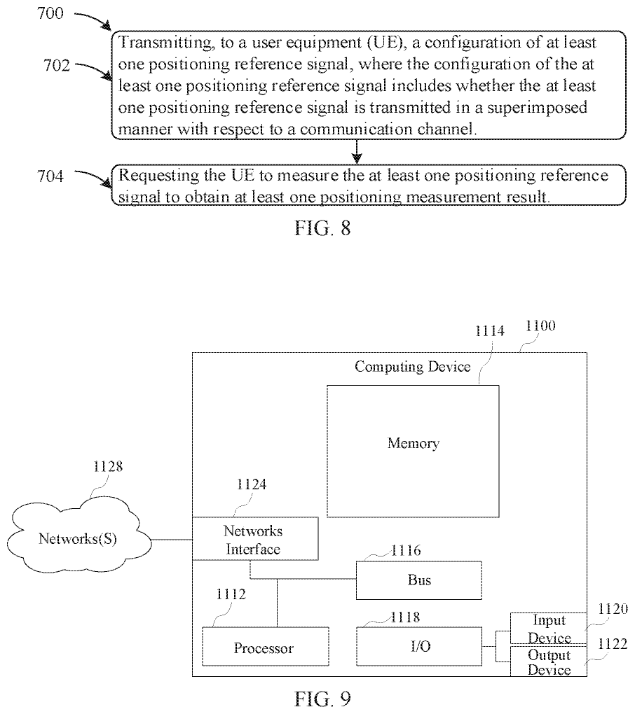

FIG. 8 is an example of a method 700 of wireless communication performed by a base station according to an embodiment of the present disclosure. The method 700 of wireless communication performed by the base station is configured to implement some embodiments of the disclosure. Some embodiments of the disclosure may be implemented into the method 700 of wireless communication performed by the base station using any suitably configured hardware and/or software. In some embodiments, the method 700 of wireless communication performed by the base station includes: an operation 702, transmitting, to a user equipment (UE), a configuration of at least one positioning reference signal, wherein the configuration of the at least one positioning reference signal includes whether the at least one positioning reference signal is transmitted in a superimposed manner with respect to a communication channel, and an operation 704, requesting the UE to measure the at least one positioning reference signal to obtain at least one positioning measurement result. This can solve issues in the prior art and other issues, boost a spectral efficiency of a whole system, reduce a system transmission latency, and/or reduce a positioning service latency.

In some embodiments, the at least one positioning reference signal being transmitted in the superimposed manner with respect to the communication channel includes the at least one positioning reference signal being transmitted on a same time-frequency resource as a physical downlink control channel (PDCCH), a physical downlink shared channel (PDSCH), and/or a channel state information reference signal (CSI-RS). In some embodiments, the at least one positioning measurement result includes an arrival time difference of the at least one positioning reference signal of different transmit points (TPs), a reference signal received power (RSRP) measurement of the at least one positioning reference signal, a carrier phase measurement of the at least one positioning reference signal, and/or or a measurement of arrival time of the at least one positioning reference signal. In some embodiments, requesting the UE to measure the at least one positioning reference signal includes: requesting the UE to measure the at least one positioning reference signal transmitted in the superimposed manner outside a measurement gap, wherein the measurement gap is a time window within which there is no transmission of other channels or other reference signals.

In some embodiments, the base station provides a power-scaling factor to the UE when the at least one positioning reference signal is transmitted in a superimposed manner. In some embodiments, the power-scaling factor is used to indicate a power offset between the at least one positioning reference signal and the PDCCH, the PDSCH, or the CSI-RS. In some embodiments, if the at least one positioning reference signal transmitted in the superimposed manner is not measured or the at least one positioning reference signal dose not overlap the communication channel, the base station requests the UE to measure the at least one positioning reference signal within a measurement gap. In some embodiments, the base station requests the UE to use a positioning service level to determine whether measuring the at least one positioning reference signal transmitted in the superimposed manner to obtain at least one positioning measurement result. In some embodiments, the base station is configured to transmit a PDCCH, a PDSCH and/or a CSI-RS to the UE. In some embodiments, the base station indicates to the UE whether the at least one positioning reference signal is transmitted along with the PDCCH, the PDSCH or the CSI-RS in the superimposed manner.

### Exemplary Technical Solutions

In some embodiments, a UE can be provided with the configuration of positioning reference signal and the UE can be configured with that the positioning reference signal can be transmitted with a superimposed manner with respect to the other communication channel including PDCCH and PDSCH, where the positioning reference signal can be transmitted on the same time-frequency resource as the PDCCH and/or PDSCH. The UE can be configured to measure positioning reference signals that are transmitted in a superimposed manner to obtain positioning measurement results, for example, which can be the arrival time difference of positioning reference signal of different TPs, can be the RSRP measurement of positioning reference signal, or can be the carrier phase measurement of the positioning reference signal or can be the measurement of arrival time of the positioning reference signal. To measure a positioning reference signal that can support superimposed transmission, the UE does not need to request a measurement gap, which is a time window within which there is no transmission of other channels or other reference signals. For a positioning reference signal, the UE can be provided with a power-scaling factor when the positioning reference signal is transmitted with a superimposed manner. The power-scaling factor can be used to indicate the power offset between the positioning reference signal and the PDCCH, PDSCH, and/or CSI-RS.

In some embodiments, in a first method, a UE can be configured with one or more positioning reference signals. For each positioning reference signal, the UE can be provided with a power-scaling factor which is used to indicate the power offset between the positioning reference signal and the PDCCH, PDSCH, and/or CSI-RS when the positioning reference signal is transmitted in a superimposed manner with respect to the PDCCH, PDSCH, and/or CSI-RS.

In some embodiments, in a second method, a UE can be configured with one or more positioning reference signals. For each positioning reference signal, the UE can be provided with a first indicator that indicates whether the positioning reference signal is transmitted in a superimposed manner with respect to PDCCH, PDSCH, and/or CSI-RS. For each positioning reference signal, the UE can be provided with a second indicator that indicates whether the UE can measure the positioning reference signal when this positioning reference signal is transmitted in a superimposed manner with respect to PDCCH, PDSCH, and/or CSI-RS.

In some examples, if a positioning reference signal can be measured when this positioning reference signal is transmitted with a superimposed manner, the UE can measure the positioning reference signal outside measurement gap and the UE does not need to request measurement gap for measuring the positioning reference signal.

In some examples, if a positioning reference signal cannot be measured when this positioning reference signal is transmitted with a superimposed manner, the UE is supposed to measure this positioning reference signal within a measurement gap or when this positioning reference signal does not overlap with PDCCH, PDSCH, and/or CSI-RS.

In some embodiments, in a third method, the UE can be configured with one or more positioning reference signals and the UE can be configured to measure positioning reference signal to obtain some positioning measurement results. The UE can be requested to obtain measurement results according to whether the positioning reference signal is transmitted in a superimposed manner.

In one example, the UE can be requested to obtain arrival time-related positioning measurement from the positioning reference signals that are not transmitted in a superimposed manner.

In one example, the UE can be requested to obtain RSRP type measurement from the positioning reference signal that can be transmitted in a superimposed manner or not transmitted in a superimposed manner.

In one example, the UE can be requested to obtain carrier phase measurement from the positioning reference signals that are not transmitted in a superimposed manner.

In one example, the UE can be requested to use the requested positioning service level to determine if he can obtain measurement results from the positioning reference signals that are transmitted in a superimposed manner. For example, if the positioning accuracy is below some threshold, the UE can be requested to not measure positioning reference signals that are transmitted in a superimposed manner. For example, if the latency of positioning service is below some threshold, the UE can be requested to measure positioning reference signals that are transmitted in a superimposed manner.

In some embodiments, in a fourth method, the UE can be configured with one or more positioning reference signals and the UE can be requested to measure the positioning reference signal and then report positioning measurement result. The positioning measurement result can be: the difference of arrival time of different TP or positioning reference signals, the RSRP measurement of positioning reference signal, the angle of arrival of positioning reference signal, the carrier phase measured from the positioning reference signal and/or the time difference between downlink arrival time and the uplink transmission time. For each reported positioning measurement result, the UE can be requested to report whether the reported positioning measurement result is obtained from a positioning reference signal that is transmitted in a superimposed manner or not, in other word, whether the corresponding positioning reference signal overlaps with PDCCH, PDSCH, and/or CSI-RS.

In one example, for each reported positioning measurement result, the UE can report a corresponding SIP_indicator that can indicate the corresponding positioning reference signal is transmitted in a superimposed manner or not. Example value of the SIP_indicator can be 0 or 1. SIP_indicator=1 for one reported positioning measurement result indicates that the positioning reference signal used to obtain the reported positioning measurement result is transmitted in a superimposed manner, and SIP_indicator=0 for one reported positioning measurement result indicates that the positioning reference signal used to obtain the reported positioning measurement result is not transmitted in a superimposed manner.

In some embodiments, in one method, a UE can be configured to receive PDCCH, PDSCH and/or CSI-RS. For each of PDCCH, PDSCH and CSI-RS, the UE can be indicated whether positioning reference signal is transmitted along with the PDCCH, PDSCH or CSI-RS in a superimposed manner.

In one example, for a PDCCH, the UE can be indicated that positioning reference signal is transmitted in a superimposed manner with this PDCCH. The UE can also be provided with the allocation of time-frequency resource where the positioning reference signal overlaps with the PDCCH and/or the power offset between the overlapping positioning reference signal and the PDCCH.

In one example, for a PDSCH, the UE can be indicated that positioning reference signal is transmitted in a superimposed manner with this PDSCH. The UE can also be provided with the allocation of time-frequency resource where the positioning reference signal overlaps with the PDSCH and/or the power offset between the overlapping positioning reference signal and the PDSCH.

In one example, for a CSI-RS, the UE can be indicated that positioning reference signal is transmitted in a superimposed manner with this CSI-RS. The UE can also be provided with the allocation of time-frequency resource where the positioning reference signal overlaps with the CSI-RS and/or the power offset between the overlapping positioning reference signal and the CSI-RS.

In summary, in some embodiments, the proposed methods can boost the spectral efficiency of the whole system through transmitting PDCCH, PDSCH, and/or CSI-RS and positioning reference signal on the same time-frequency resource. They can also reduce the system transmission latency and positioning service latency.

Commercial interests for some embodiments are as follows. 1. Solve issues in the prior art and other issues. 2. Boost a spectral efficiency of a whole system. 3. Reduce a system transmission latency. 4. Reduce a positioning service latency. 5. Provide a good communication performance. 6. Provide high reliability. Some embodiments of the present disclosure can be used in many applications. Some embodiments of the present disclosure are used by chipset vendors, video system development vendors, automakers including cars, trains, trucks, buses, bicycles, moto-bikes, helmets, and etc., drones (unmanned aerial vehicles), smartphone makers, communication devices for public safety use, AR/VR/MR device maker for example gaming, conference/seminar, education purposes. Some embodiments of the present disclosure are a combination of “techniques/processes” that can be adopted in video standards to create an end product. Some embodiments of the present disclosure propose technical mechanisms. The at least one proposed solution, method, system, and apparatus of some embodiments of the present disclosure may be used for current and/or new/future standards regarding communication systems such as a UE, a base station, and/or a communication system. Compatible products follow at least one proposed solution, method, system, and apparatus of some embodiments of the present disclosure. The proposed solution, method, system, and apparatus are widely used in a UE, a base station, and/or a communication system. With the implementation of the at least one proposed solution, method, system, and apparatus of some embodiments of the present disclosure, at least one modification to methods and apparatus of wireless communication are considered for standardizing.

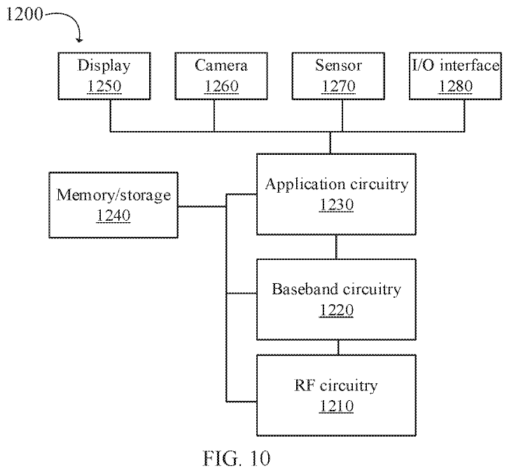

FIG. 9 is an example of a computing device 1100 according to an embodiment of the present disclosure. Any suitable computing device can be used for performing the operations described herein. For example, FIG. 9 illustrates an example of the computing device 1100 that can implement some embodiments of FIG. 1A to FIG. 8 using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a non-transitory computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to some embodiments of FIG. 1A to FIG. 8. The program code may be resident in the memory 1114 or any suitable non-transitory computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

FIG. 10 is a block diagram of an example of a communication system 1200 according to an embodiment of the present disclosure. Embodiments described herein may be implemented into the communication system 1200 using any suitably configured hardware and/or software. FIG. 10 illustrates the communication system 1200 including a radio frequency (RF) circuitry 1210, a baseband circuitry 1220, an application circuitry 1230, a memory/storage 1240, a display 1250, a camera 1260, a sensor 1270, and an input/output (I/O) interface 1280, coupled with each other at least as illustrated.

The application circuitry 1230 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system. The communication system 1200 can execute program code that configures the application circuitry 1230 to perform one or more of the operations described above with respect to some embodiments of FIG. 1A to FIG. 8. The program code may be resident in the application circuitry 1230 or any suitable non-transitory computer-readable medium and may be executed by the application circuitry 1230 or any other suitable processor.

The baseband circuitry 1220 may include circuitry such as, but not limited to, one or more single-core or multi-core processors. The processors may include a baseband processor. The baseband circuitry may handle various radio control functions that may enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 1220 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 1210 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 1210 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to some embodiments of FIG. 1A to FIG. 8 may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 1240 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 1280 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 1270 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 1250 may include a display, such as a liquid crystal display and a touch screen display. In various embodiments, the communication system 1200 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and operations described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the operations disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A method of wireless communication performed by a user equipment (UE), comprising:
receiving a configuration of at least one positioning reference signal from a base station, wherein the configuration of the at least one positioning reference signal comprises whether the at least one positioning reference signal is transmitted in a superimposed manner with respect to a communication channel; and
measuring the at least one positioning reference signal to obtain at least one positioning measurement result.

2. The method of claim 1, wherein the at least one positioning reference signal being transmitted in the superimposed manner with respect to the communication channel comprises the at least one positioning reference signal being transmitted on a same time-frequency resource as a physical downlink control channel (PDCCH), a physical downlink shared channel (PDSCH), and/or a channel state information reference signal (CSI-RS).

3. The method of claim 1, wherein the at least one positioning measurement result comprises an arrival time difference of the at least one positioning reference signal of different transmit points (TPs), a reference signal received power (RSRP) measurement of the at least one positioning reference signal, a carrier phase measurement of the at least one positioning reference signal, and/or or a measurement of arrival time of the at least one positioning reference signal.

4. The method of claim 1, wherein measuring the at least one positioning reference signal comprises:
measuring the at least one positioning reference signal transmitted in the superimposed manner outside a measurement gap, and the measurement gap is a time window within which there is no transmission of other channels or other reference signals.

5. The method of claim 1, wherein the UE is provided with a power-scaling factor when the at least one positioning reference signal is transmitted in a superimposed manner.

6. The method of claim 5, wherein the power-scaling factor is used to indicate a power offset between the at least one positioning reference signal and the PDCCH, the PDSCH, or the CSI-RS.

7. The method of claim 1, wherein if the at least one positioning reference signal transmitted in the superimposed manner is not measured or the at least one positioning reference signal dose not overlap the communication channel, the UE is supposed to measure the at least one positioning reference signal within a measurement gap.

8. The method of claim 1, wherein the UE is requested to use a positioning service level to determine whether measuring the at least one positioning reference signal transmitted in the superimposed manner to obtain at least one positioning measurement result.

9. The method of claim 1, wherein the UE is configured to receive a PDCCH, a PDSCH and/or a CSI-RS.

10. The method of claim 9, wherein the UE is indicated whether the at least one positioning reference signal is transmitted along with the PDCCH, the PDSCH or the CSI-RS in the superimposed manner.

11. A method of wireless communication performed by a base station, comprising:
transmitting, to a user equipment (UE), a configuration of at least one positioning reference signal, wherein the configuration of the at least one positioning reference signal comprises whether the at least one positioning reference signal is transmitted in a superimposed manner with respect to a communication channel; and
requesting the UE to measure the at least one positioning reference signal to obtain at least one positioning measurement result.

12. The method of claim 11, wherein the at least one positioning reference signal being transmitted in the superimposed manner with respect to the communication channel comprises the at least one positioning reference signal being transmitted on a same time-frequency resource as a physical downlink control channel (PDCCH), a physical downlink shared channel (PDSCH), and/or a channel state information reference signal (CSI-RS).

13. The method of claim 11, wherein the at least one positioning measurement result comprises an arrival time difference of the at least one positioning reference signal of different transmit points (TPs), a reference signal received power (RSRP) measurement of the at least one positioning reference signal, a carrier phase measurement of the at least one positioning reference signal, and/or or a measurement of arrival time of the at least one positioning reference signal.

14. The method of claim 11, wherein requesting the UE to measure the at least one positioning reference signal comprises:
requesting the UE to measure the at least one positioning reference signal transmitted in the superimposed manner outside a measurement gap, wherein the measurement gap is a time window within which there is no transmission of other channels or other reference signals.

15. The method of claim 11, wherein the base station provides a power-scaling factor to the UE when the at least one positioning reference signal is transmitted in a superimposed manner.

16. A user equipment (UE), comprising:
a memory;
a transceiver; and
a processor coupled to the memory and the transceiver;
wherein the UE is configured to perform the following steps:
receiving a configuration of at least one positioning reference signal from a base station, wherein the configuration of the at least one positioning reference signal comprises whether the at least one positioning reference signal is transmitted in a superimposed manner with respect to a communication channel; and
measuring the at least one positioning reference signal to obtain at least one positioning measurement result.

17. The UE of claim 16, wherein the at least one positioning reference signal being transmitted in the superimposed manner with respect to the communication channel comprises the at least one positioning reference signal being transmitted on a same time-frequency resource as a physical downlink control channel (PDCCH), a physical downlink shared channel (PDSCH), and/or a channel state information reference signal (CSI-RS).

18. The UE of claim 16, wherein measuring the at least one positioning reference signal comprises:
measuring the at least one positioning reference signal transmitted in the superimposed manner outside a measurement gap, and the measurement gap is a time window within which there is no transmission of other channels or other reference signals.

19. The UE of claim 16, wherein the UE is provided with a power-scaling factor when the at least one positioning reference signal is transmitted in a superimposed manner.

20. A base station, comprising:
a memory;
a transceiver; and
a processor coupled to the memory and the transceiver;
wherein the base station is configured to perform the method of claim 11.
